(19) United States
(12) Patent Application Publication
(10) Pub. No.: US 2014/0188726 A1
(43) Pub. Date: Jul. 3, 2014

(54) PAYMENT VALIDATION SYSTEMS AND METHODS

(71) Applicant: WAL-MART STORES, INC., Bentonville, AR (US)

(72) Inventors: Madhavan Kandhadai Vasantham, Foster City, CA (US); Sreekanth Sreedhararaj, Foster City, CA (US)

(73) Assignee: Wal-Mart Stores, Inc., Bentonville, AR (US)

(21) Appl. No.: 13/730,755

(22) Filed: Dec. 28, 2012

(51) Int. Cl. G06Q 20/40

(52) U.S. Cl. CPC G06Q 20/40
USPC 705/44

(57) ABSTRACT

Example payment validation systems and methods are described. In one implementation, a request is received from a user to pay for an online order using an image of a negotiable instrument. Information associated with the negotiable instrument is identified from the image of the negotiable instrument. The identified information is communicated to a validation service. An indication is received from the validation service regarding whether the negotiable instrument is valid. If the negotiable instrument is valid, payment for the online order is processed using the image of the negotiable instrument.

### TECHNICAL FIELD

The present disclosure relates to online payment systems and methods that support payment to an online marketplace using a negotiable instrument.

### BACKGROUND

Purchasers of products or services typically have multiple payment options, such as cash, check, credit card, debit card, and gift card, as well as payment services such as PayPal™, BillMeLater™, and the like. With the increased popularity and convenience of online shopping, an increased number of purchasers are buying products and services from online sources. However, when purchasing from online sources, purchasers are typically limited to certain forms of payment, such as credit cards, debit cards, and gift cards. Purchasers using online sources are not typically able to present a check, or other negotiable instrument, for payment of an order. However, many purchasers still prefer to pay with a check as opposed to a credit card, debit card, or other payment method.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram depicting an embodiment of a server associated with an online marketplace.

FIG. 3 is a block diagram depicting an embodiment of a user device.

FIGS. 4A and 4B represent a flow diagram depicting an embodiment of a method for purchasing a product through an online marketplace using a negotiable instrument.

FIG. 5 is a flow diagram depicting an embodiment of a method for distributing funds in excess of a purchase amount.

FIGS. 6A and 6B represent a flow diagram depicting an embodiment of a method for validating a negotiable instrument presented for payment of an online order.

FIGS. 7A and 7B represent a flow diagram depicting an embodiment of a method for placing an order through a user device.

FIG. 8 depicts an example illustration of a negotiable instrument.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein allow a user to pay for a purchase through an online marketplace using a negotiable instrument. A “negotiable instrument” includes any written order or unconditional promise to pay a particular amount of money on demand or at a particular time. Example negotiable instruments include personal checks, third party checks, promissory notes, demand drafts, and bills of exchange. As described herein, a user may select one or more items for purchase through an online marketplace. When the order is complete, the user presents an image of a negotiable instrument, such as an image of a physical check, to the online marketplace as payment for the order. The online marketplace validates the image of the negotiable instrument and, if valid, the negotiable instrument is accepted as payment for the order.

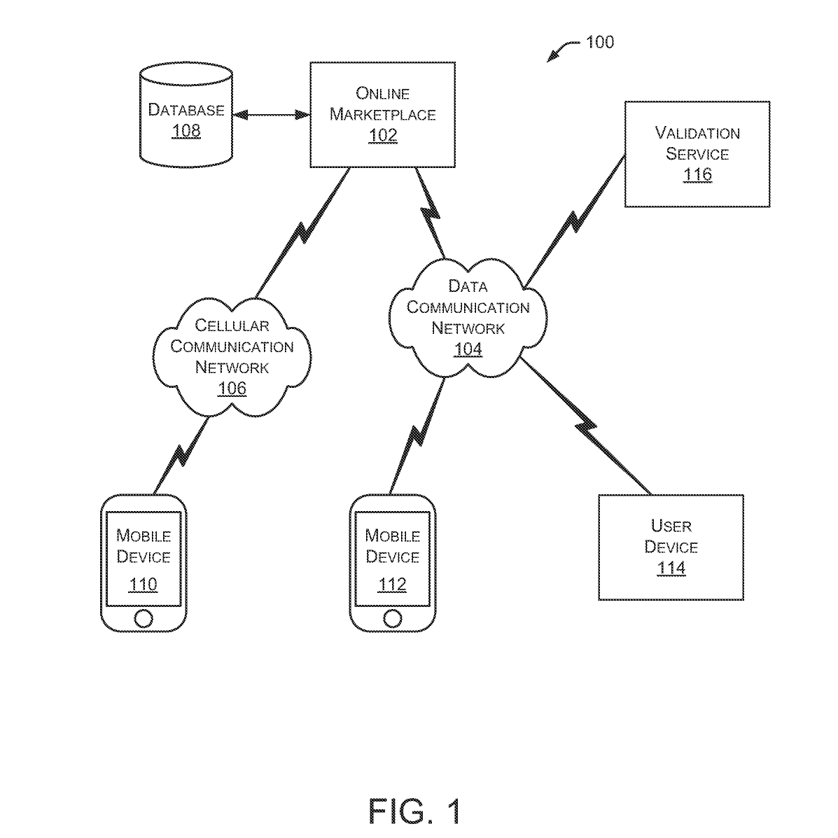

FIG. 1 is a block diagram depicting an environment 100 within which an example embodiment may be implemented. Environment 100 includes an online marketplace 102 coupled to a data communication network 104, such as the Internet, and a cellular communication network 106. Online marketplace 102 includes any type of Web site or online service that is accessible by one or more users to purchase any type of product or service. Online marketplace 102 may be implemented using one or more systems and/or services, such as web servers, application servers, and the like. A particular online marketplace 102 may offer products or services associated with a single entity (e.g., a single merchant) or from multiple different entities. In some embodiments, online marketplace 102 is implemented by the entity (e.g., merchant) offering the products or services. Online marketplace 102 may also be referred to as an “ecommerce site,” a “mobile commerce site,” an “ecommerce marketplace,” or an “online ecommerce marketplace.” Online marketplace 102 is also coupled to a database 108, which stores, for example, information associated with the products and services available through online marketplace 102. In some embodiments, database 108 stores data utilized by one or more servers to implement online marketplace 102.

Online marketplace 102 communicates with various systems, services, and devices through data communication network 104. Data communication network 104 may utilize any communication protocol and any type of communication medium. In some embodiments, data communication network 104 is a combination of two or more networks coupled to one another. Online marketplace 102 also communicates with various systems and devices, such as mobile devices, through cellular communication network 106, which may utilize any communication protocol and any type of communication medium. In some embodiments, cellular communication network 106 is a combination of two or more networks coupled to one another.

As shown in environment 100, a mobile device 110 communicates with online marketplace 102 through cellular communication network 106. Although a single mobile device 110 is shown in FIG. 1, particular embodiments may include any number of mobile devices (and non-mobile devices) communicating with online marketplace 102 through cellular communication network 106. A second mobile device 112 communicates with online marketplace 102 through data communication network 104. Although one mobile device 112 is shown communicating through data communication network 104, particular embodiments may include any number of mobile devices communicating with online marketplace 102 through data communication network 104. Mobile devices 110 and 112 include any type of device capable of communicating with online marketplace 102 through cellular communication network 106 or data communication network 104, such as a cellular phone, a smart phone, a tablet computer, a laptop computer, a desktop computer, a portable entertainment device, a portable gaming device, and the like.

Additionally, a user device 114 communicates with online marketplace 102 through data communication network 104. User device 114 includes any type of device capable of communicating with online marketplace 102 through data communication network 104, such as a tablet computer, a laptop computer, a desktop computer, a portable entertainment device, a portable gaming device, a game console, a set top box, and the like.

A validation service 116 is also coupled to data communication network 104. Validation service 116 performs various functions related to the validation of negotiable instruments and financial transactions, as discussed herein. Although a single validation service 116 is shown in FIG. 1, particular environments 100 may include any number of different validation services 116 coupled to data communication network 104. In alternate embodiments, one or more validation services are coupled directly to online marketplace 102.

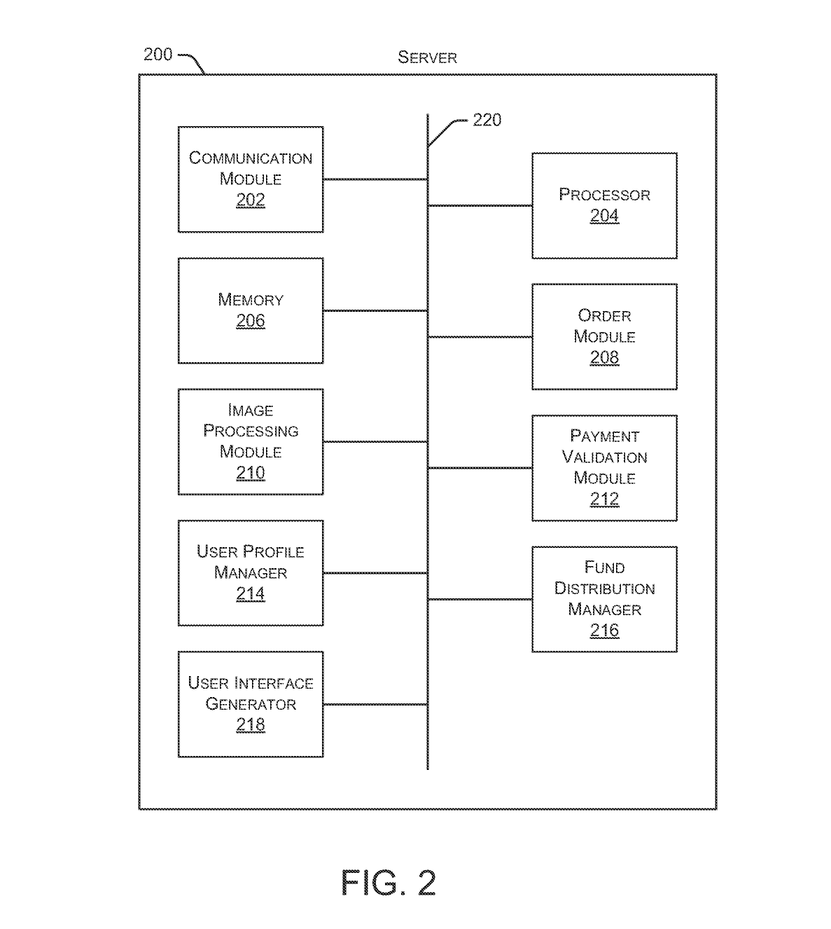

FIG. 2 is a block diagram depicting an embodiment of a server 200 associated with online marketplace 102. Server 200 performs various functions related to the operation of online marketplace 102, as discussed herein. In some embodiments, online marketplace 102 includes multiple servers 200 that cooperatively implement the functions described herein. Server 200 includes a communication module 202, a processor 204, and a memory 206. Communication module 202 allows server 200 to communicate with other systems, such as communication networks, other servers, mobile devices 110 and 112, user device 114, validation service 116, and the like. Processor 204 executes various instructions to implement the functionality provided by server 200. Memory 206 stores these instructions as well as other data used by processor 204 and other modules contained in server 200.

Server 200 also includes an order module 208, which handles the receiving and processing of orders from multiple users. In some embodiments, order module 208 manages online shopping carts, order checkout processes, shipping policies, and the like. An image processing module 210 performs, for example, various tasks associated with the analysis of images, such as images of negotiable instruments. As discussed herein, image processing module 210 may identify various information contained in an image of a negotiable instrument. A payment validation module 212 performs various functions associated with the validation of a payment received from a user, such as the validation of a negotiable instrument presented for payment by the user. Additional details regarding the validation of payments are provided herein.

Server 200 further includes a user profile manager 214, which maintains various information about users of online marketplace 102. For example, user profile manager 214 may store information regarding user names, user accounts, user purchase history, and the like. A fund distribution manager 216 handles various payments and other distributions of funds. As discussed herein, if a user presents a negotiable instrument having a value that exceeds the amount of an order, fund distribution manager 216 will handle the distribution of the excess funds as specified by the user. A user interface generator 218 creates data to present various user interfaces to a user of mobile device 110, 112, or user device 114. Example user interfaces include message display interfaces, order entry interfaces, order confirmation interfaces, and the like. A data communication bus 220 allows the various systems and components of server 200 to communicate with one another.

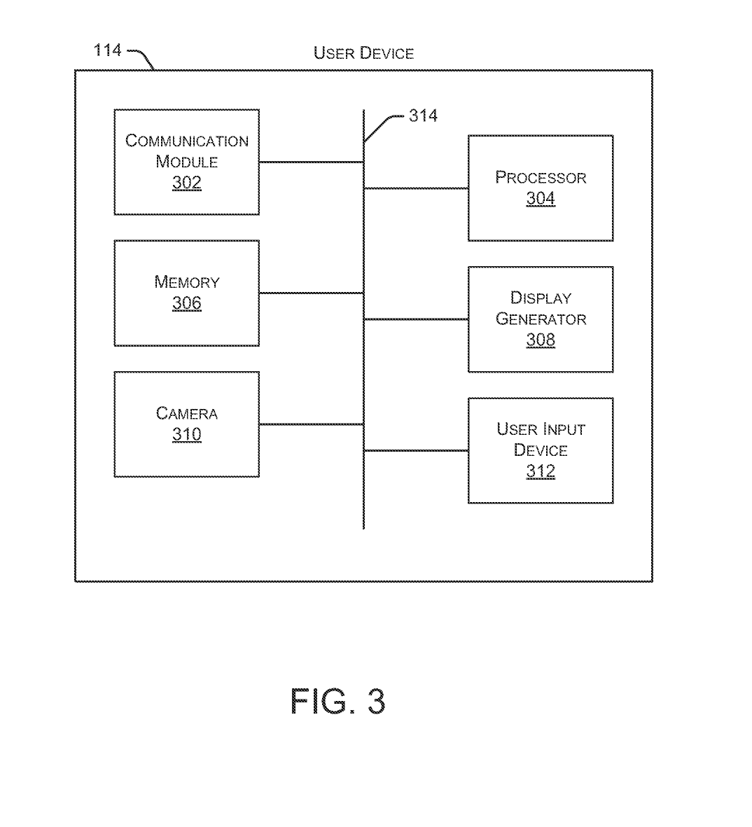

FIG. 3 is a block diagram depicting an embodiment of user device 114. User device 114 is operated by a user to interact with online marketplace 102 to place orders, present payment for orders, receive order status updates, and the like. User device 114 includes a communication module 302, a processor 304, and a memory 306. Communication module 302 allows user device 114 to communicate with other systems, such as communication networks, other user devices, online marketplace 102, and the like. Processor 304 executes various instructions to implement the functionality described herein with respect to user device 114. Memory 306 stores these instructions as well as other data used by processor 304 and other modules contained in user device 114.

User device 114 also includes a display generator 308, which generates various signals that enable a display device to present information to a user of the device. In some embodiments, display generator 308 generates various signals that present a user interface to the user of user device 114. A camera 310 in user device 114 is capable of capturing images, such as an image of a negotiable instrument. A user input device 312 allows a user to interact with user device 114. Example user input devices 312 include pointing devices, buttons, switches, touch-sensitive portions of a touch-sensitive display device, and the like. A data communication bus 314 allows the various systems and components of user device 114 to communicate with one another. In some embodiments, systems and components similar to those discussed above with respect to user device 114 are included in mobile devices 110 and 112.

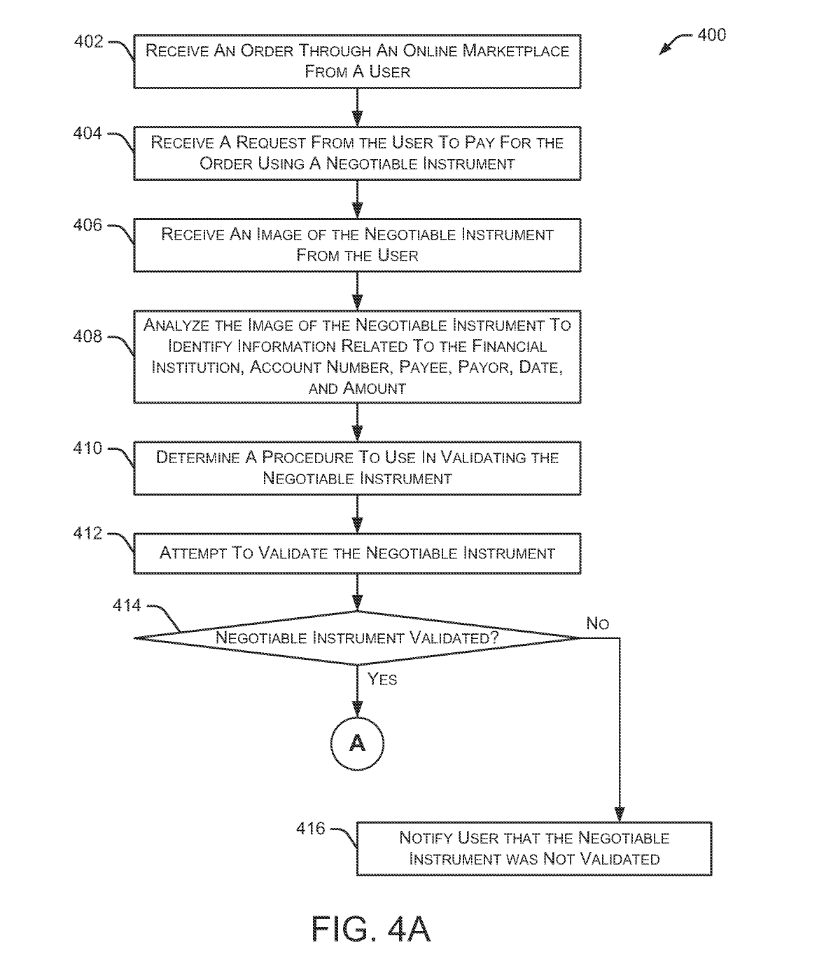

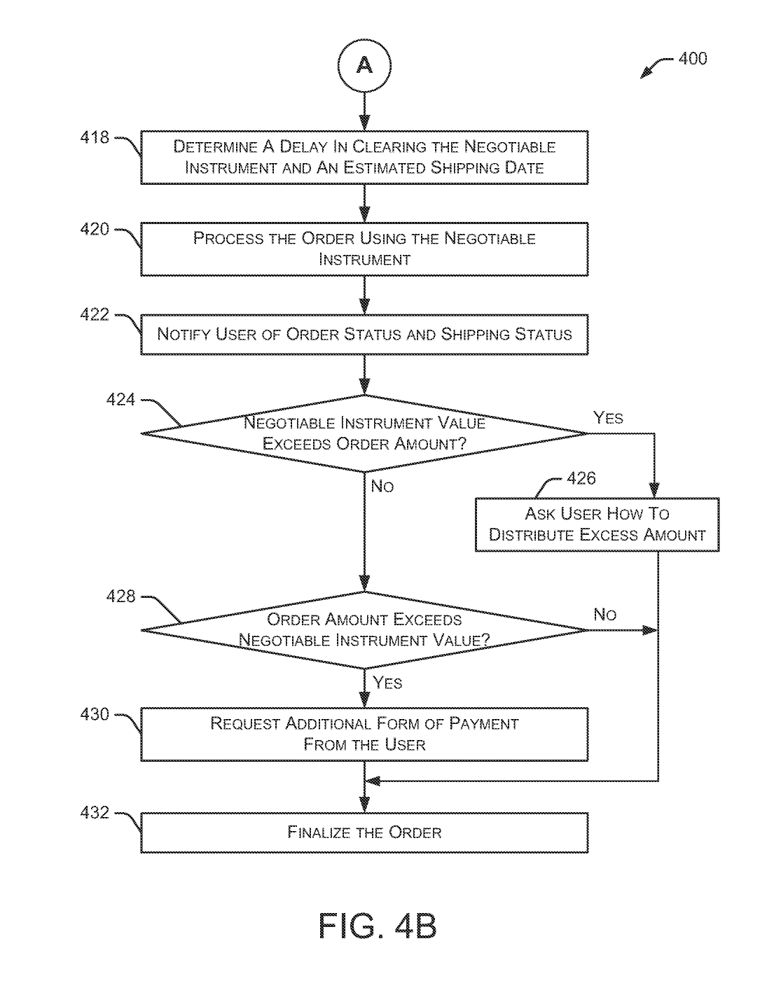

FIGS. 4A and 4B represent a flow diagram depicting an embodiment of a method 400 for purchasing a product through an online marketplace using a negotiable instrument.

Initially, an order is received through an online marketplace from a user at 402. The user may access the online marketplace using any type of device, such as a mobile device or other computing device as discussed herein. The online marketplace receives a request from the user to pay for the order using a negotiable instrument at 404. In this example, the negotiable instrument is a check made payable to the user, such as a payroll check, refund check, or a personal check from a friend of the user. The online marketplace receives an image of the negotiable instrument from the user at 406. The user can generate an image of the negotiable instrument by, for example, taking a picture of the negotiable instrument or scanning the negotiable instrument using a document scanning device. In some embodiments, the user accesses an image uploading feature through the online marketplace. This image uploading feature simplifies the image uploading procedure for the user. In other embodiments, the user may download an application into a smart phone or other mobile device. This application provides instructions to the user for taking a photo of a negotiable instrument and automatically uploads the photo of the negotiable instrument to the online marketplace.

The method 400 continues by analyzing the image of the negotiable instrument to identify information related to the negotiable instrument at 408. This information includes, for example, a financial institution associated with the negotiable instrument, an account number, a routing number, a check number, a payor, a payee, a date, an amount, a memo entry, and a signature. The identified information is used to validate and process the negotiable instrument. The method 400 determines a procedure to use in validating the negotiable instrument at 410. An attempt is made to validate the negotiable instrument at 412 using the procedure determined above at 410. If the negotiable instrument is not validated at 414, the method 400 notifies the user that the negotiable instrument was not validated at 416.

Referring to FIG. 4B, if the negotiable instrument is validated at 414, the method 400 determines a delay in clearing the negotiable instrument and an estimated shipping date at 418. When processing a negotiable instrument, the initial validation at 414 does not guarantee that the negotiable instrument will “clear” the issuing financial institution. Thus, the online marketplace may add a delay (e.g., two or three days) before actually shipping the order to be certain the negotiable instrument has cleared. The added delay may depend on various factors, such as the amount of the negotiable instrument, the issuing financial institution, and so forth. In some embodiments, the added delay will vary based on the time required to complete a fraud verification procedure and guarantee the funds if the fraud verification is successful. In these embodiments, if the fraud verification is not successful, the order is canceled and the user is notified of the order cancellation. The method 400 processes the order using the negotiable instrument at 420, subject to the delayed shipping noted above. The user is then notified of the order status and the shipping status at 422.

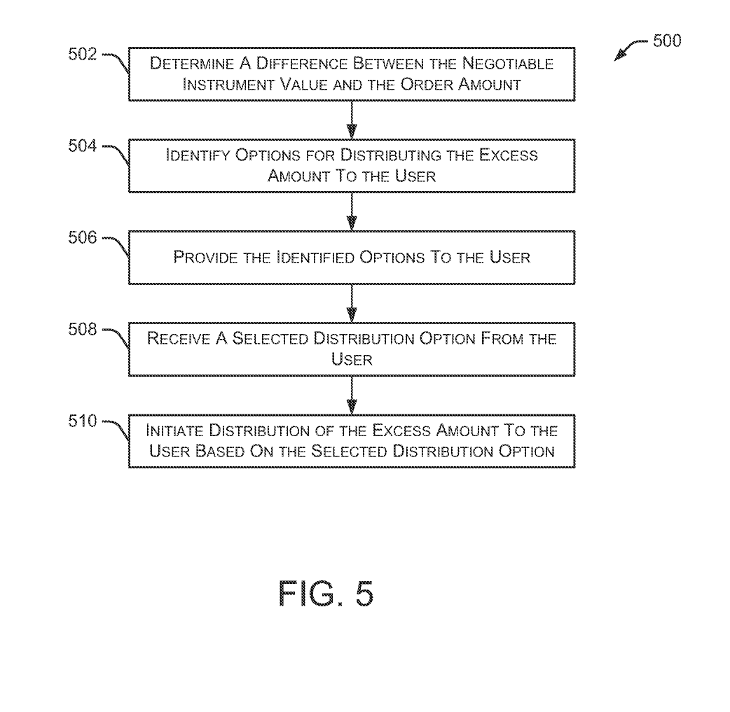

Since the user is presenting a negotiable instrument with a particular value, there is a likelihood that the value of the negotiable instrument will not match the amount of the order. For example, if the negotiable instrument is a paycheck for $523.76, it is unlikely that the order amount will be exactly $423.76. Thus, method 400 determines, at 424, whether the negotiable instrument value exceeds the order amount. If the negotiable instrument value exceeds the order amount, the user is asked how to distribute the excess amount at 426. Additional details regarding the distribution of the excess amount are discussed herein with respect to FIG. 5.

If the negotiable instrument value does not exceed the order amount, the method 400 determines whether the order amount exceeds the negotiable instrument value at 428. If the order amount exceeds the negotiable instrument value, then additional funds are necessary to complete payment for the order. In this situation, a request for an additional form of payment is requested from the user at 430. The additional form of payment includes any payment method accepted by the online merchant, such as another negotiable instrument, credit card, debit card, gift card, and the like. After handling any differences between the negotiable instrument value and the order amount, the method 400 finalizes the order at 432. This finalization of the order may include sending an order confirmation to the user via email, text message, and the like.

FIG. 5 is a flow diagram depicting an embodiment of a method 500 for distributing funds in excess of a purchase amount. Initially, a difference is determined between the negotiable instrument value and the order amount at 502. The method 500 identifies options for distributing the excess amount to the user at 504. Possible options include depositing the excess funds into the user's bank account, issuing a check to the user, issuing a store credit to the user, and issuing a gift card to the user. In some embodiments, an option is available to receive the excess funds in cash by visiting a physical store location. Different options may be available depending on the amount of the difference and user preferences. For example, checks may only be issued for amounts above a predetermined threshold. Similarly, for small amounts (e.g., less than $2.00), the option may be limited to a store credit.

The method 500 provides the identified options for receiving the excess amount to the user at 506. A selected distribution option is received from the user at 508. The method 500 initiates the distribution of the excess amount to the user based on the selected distribution option at 510. In alternate embodiments, the user may select to receive the excess amount using multiple options. For example, if the excess amount is $212.78, the user may choose to receive a $200.00 gift card and a store credit for the remaining $12.78. In some embodiments, the user defines a default method for processing the excess funds, such as automatically depositing the excess funds to the user's bank account.

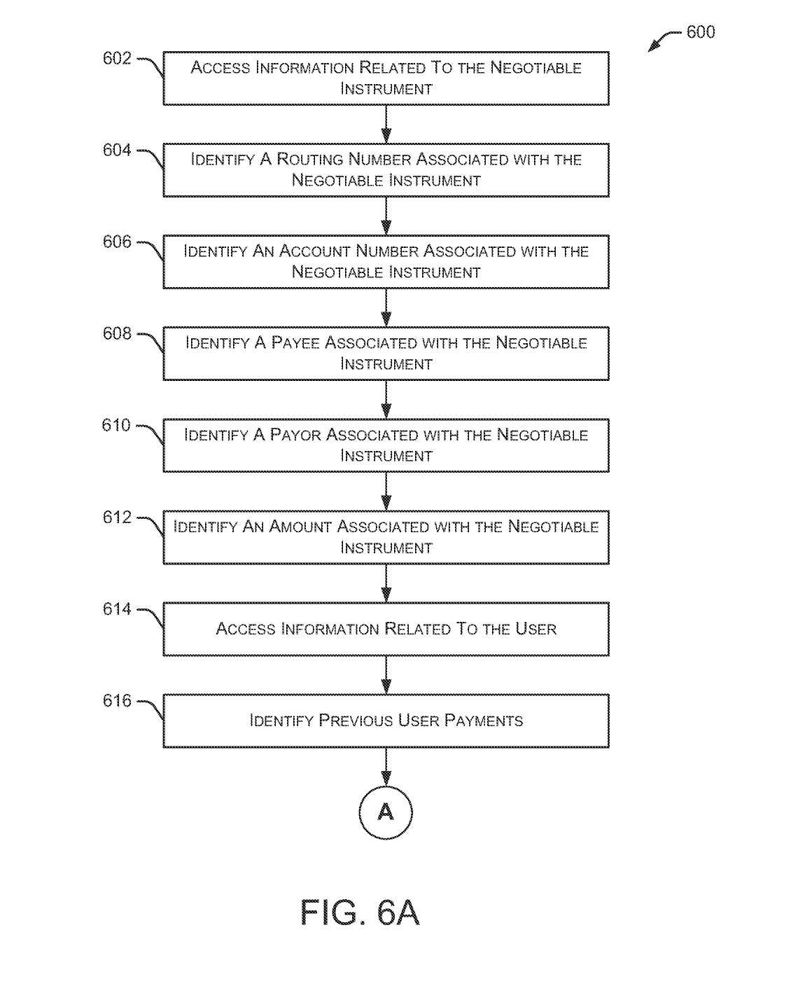

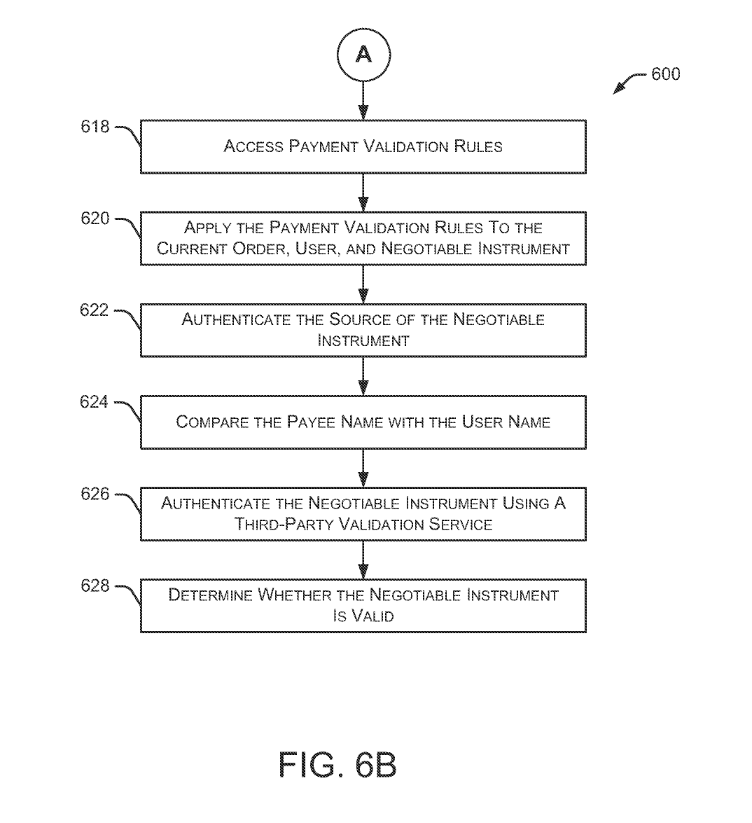

FIGS. 6A and 6B represent a flow diagram depicting an embodiment of a method 600 for validating a negotiable instrument presented for payment of an online order. Initially, the method 600 accesses information related to the negotiable instrument. In some embodiments, the information related to the negotiable instrument is accessed from a database or other storage mechanism. The accessed information is originally obtained using one or more image analysis techniques to determine the information contained in the negotiable instrument. In some embodiments, one or more image scanning algorithms are used to extract information from the negotiable instrument. In the example of FIG. 6A, the method 600 identifies a routing number associated with the negotiable instrument at 604, an account number associated with the negotiable instrument at 606, a payee associated with the negotiable instrument at 608, a payor associated with the negotiable instrument at 610, and an amount associated with the negotiable instrument at 612. In some embodiments, additional identified information also includes a financial institution associated with the negotiable instrument, a check number, a date, a memo entry, and a signature.

The method 600 continues by accessing information related to the user at 614, such as a user name, other user account information, user purchase history, and the like. Previous user payments (e.g., using a negotiable instrument) are identified at 616. Referring to FIG. 6B, the method 600 accesses payment validation rules at 618. The payment validation rules are applied to the current order, the user information, and the details of the negotiable instrument at 620. Example payment validation rules include determining an authenticity of the negotiable instrument and confirming that various information contained in the negotiable instrument has been accurately identified, such as payee name, payor name, account number, date, check number, and routing number Additional payment validation rules my authenticate the signature on the negotiable instrument and an expiration date associated with the negotiable instrument. Other payment validation rules may confirm that the bank account and routing number match the financial institution information contained in the negotiable instrument. Payment validation rules may also verify available funds to cover the amount of the negotiable instrument. The source of the negotiable instrument (e.g., the financial institution associated with the negotiable instrument) is authenticated at 622 using, for example, a third-party validation service such as those discussed herein.

The method 600 continues by comparing the payee name with the user name at 624. Additionally, the negotiable instrument is validated using one or more third-party validation services at 626. Example third-party validation services include TeleCheck® provided by First Data Corporation of Atlanta, Ga., and Certegy Check Services, Inc. of Tampa, Fla. The method 600 determines whether the negotiable instrument is valid at 628 based on application of the payment validation rules, authentication of the source of the negotiable instrument, and validation by one or more third-party validation services, as discussed above. In some embodiments, the various operations shown in FIGS. 6A and 6B are performed in a substantially sequential manner, as shown. For example, the third-party validation service is not utilized until the payment validation rules are satisfied. In other embodiments, a portion of the operations shown in FIGS. 6A and 6B are performed in parallel. For example, application of the payment validation rules may be performed substantially simultaneously with the validation by a third-party validation service.

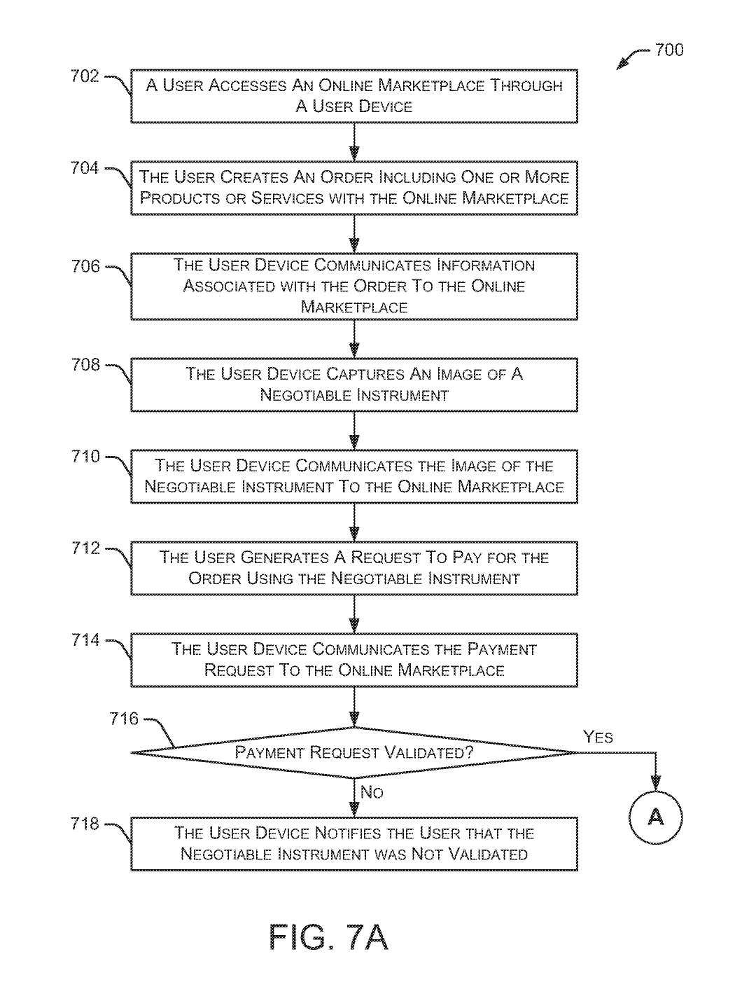

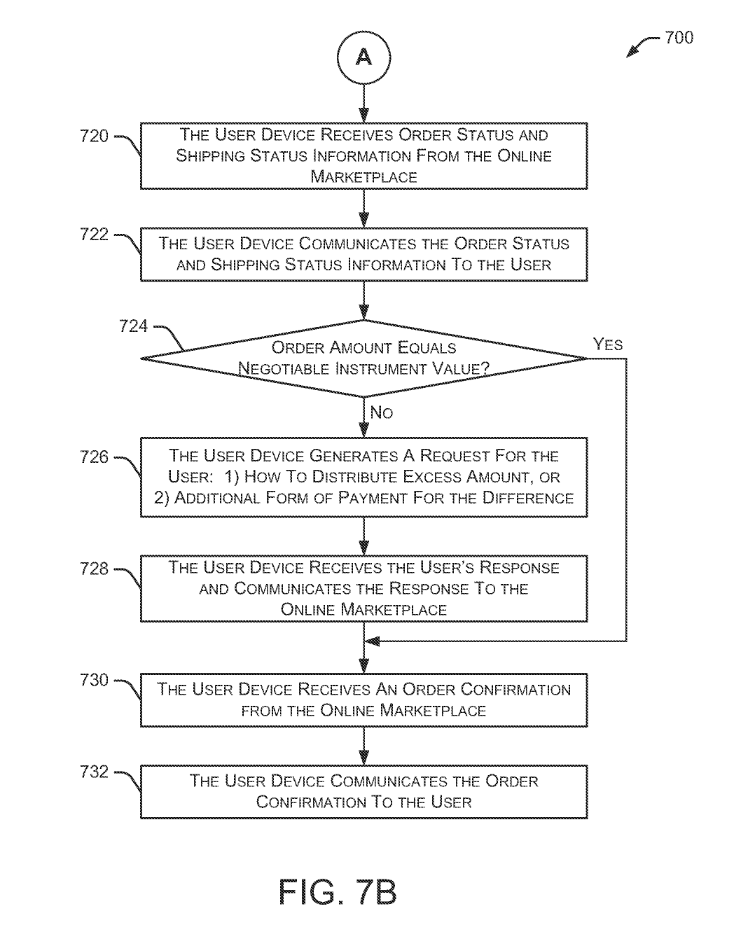

FIGS. 7A and 7B represent a flow diagram depicting an embodiment of a method 700 for placing an order through a user device. Initially, at 702, a user accesses an online marketplace through a user device, such as user device 114 discussed above. The user creates an order including one or more products or services with the online marketplace at 704. The user device communicates information associated with the order to the online marketplace at 706. Additionally, the user device captures an image of a negotiable instrument at 708 and communicates the image of the negotiable instrument to the online marketplace at 710. The image of the negotiable instrument can be captured, for example, using a camera contained in the user device. In some embodiments, a check scanning application in the user device assists with the capturing of the image of the negotiable instrument and communicating the image to the online marketplace.

The method 700 continues as the user generates a request to pay for the order using the negotiable instrument at 712. The user device communicates the payment request to the online marketplace at 714 and awaits a response from the online marketplace. If the response from the online marketplace indicates, at 716, that the payment request is not validated, the user device notifies the user that the negotiable instrument was not validated as payment for the order at 718. Referring to FIG. 7B, if the payment request is validated at 716, the user device receives order status and shipping status information from the online marketplace at 720. As discussed above, an additional delay may be imposed on orders processed using a negotiable instrument to allow time for the negotiable instrument to clear the financial institution. The user device communicates the order status and shipping status information to the user at 722.

The method 700 determines whether the order amount equals the negotiable instrument value at 724. As discussed above, it is unlikely that the order amount will equal the value of the negotiable instrument. If the order amount does not equal the negotiable instrument value, the user device generates a request for the user, at 726, based on whether the order amount is greater than or less than the negotiable instrument value. If the negotiable instrument value is greater than the order amount, the device generates a request asking the user how to distribute the excess amount. If the order amount is greater than the negotiable instrument value, the device generates a request asking the user for an additional form of payment. The user device receives a response from the user and communicates the response to the online marketplace at 728. The user's response will typically include additional information, such as the method to receive excess funds or an additional form of payment when the negotiable instrument value is less than the order amount. If the order amount equals the negotiable instrument value at 724, the method 700 skips 726 and 728, discussed above.

The method 700 continues as the user device receives an order confirmation from the online marketplace at 730. The user device communicates the order confirmation to the user at 732. The order confirmation may include a receipt indicating the form (or forms) of payment used as well as the manner in which any excess funds were distributed.

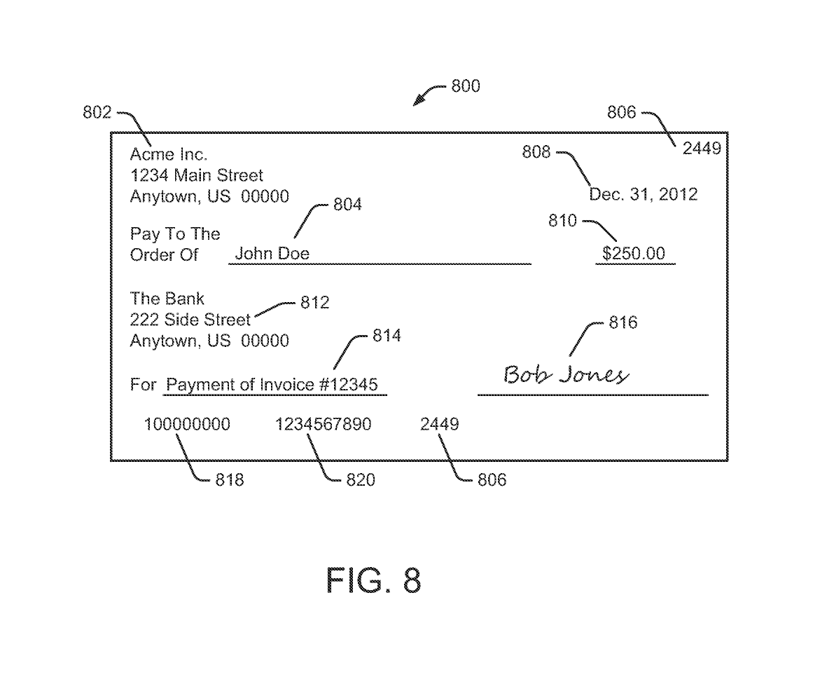

FIG. 8 depicts an example illustration of a negotiable instrument 800, which includes a payor 802, a payee 804, a check number 806, a date 808, and an amount 810. Additionally, negotiable instrument 800 identifies a financial institution 812, a memo entry 814, a signature 816, a routing number 818, and an account number 820. As discussed herein, one or more of these items of information may be utilized in processing and validating negotiable instrument 800 when presented as payment for an online order.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method of validating a negotiable instrument presented for payment of an online order, the method comprising:
receiving an image of a negotiable instrument from a user;
identifying account information associated with the negotiable instrument based on the received image;
identifying payee information associated with the negotiable instrument based on the received image;
validating, using one or more processors, the account information and payee information associated with the negotiable instrument;
responsive to validating the account information and payee information:
identifying additional information associated with the negotiable instrument;
communicating the additional information to a third-party validation service; and
receiving an indication of whether the negotiable instrument is valid from the third-party validation service.

2. The method of claim 1, the validating of the account information and payee information associated with the negotiable instrument including applying at least one payment validation rule to the account information and the payee information.

3. The method of claim 1, the additional information associated with the negotiable instrument including:
a routing number associated with the negotiable instrument;
a payor associated with the negotiable instrument; and
an amount associated with the negotiable instrument.

4. The method of claim 1, further comprising authenticating a source of the negotiable instrument.

5. The method of claim 1, further comprising comparing the payee information with a name of a user associated with the online order.

6. The method of claim 1, further comprising validating available funds to cover a payment amount associated with the negotiable instrument.

7. The method of claim 1, further comprising processing payment for the online order using the negotiable instrument responsive to receiving an indication that the negotiable instrument is valid from the third-party validation service.

8. The method of claim 1, wherein the negotiable instrument is a physical check.

9. A method comprising:
receiving a request to pay for an online order from a user;
receiving an image of a negotiable instrument from the user;
identifying, using one or more processors, information associated with the negotiable instrument from the image;
communicating the identified information to a validation service; and
receiving an indication of whether the negotiable instrument is valid from the validation service.

10. The method of claim 9, wherein the information associated with the negotiable instrument includes a routing number, an account number, a payee, and an amount.

11. The method of claim 9, wherein the information associated with the negotiable instrument includes a routing number, an account number, a payee, a payor, an amount, a date, a financial institution, and a signature.

12. The method of claim 9, further comprising processing payment for the online order using the image of the negotiable instrument responsive to receiving an indication that the negotiable instrument is valid from the validation service.

13. The method of claim 9, further comprising applying at least one payment validation rule to the identified information associated with the negotiable instrument prior to communicating the identified information to the validation service.

14. The method of claim 13, wherein the at least one payment validation rule includes at least one of authenticating a source of the negotiable instrument, comparing the payee information to a name of the user associated with the online order, and determining whether funds are available to cover a payment amount associated with the negotiable instrument.

15. The method of claim 9, wherein the negotiable instrument is a physical check.

16. An apparatus comprising:
a memory to store data associated with an online order; and
one or more processors coupled to the memory, the one or more processors configured to:
receive a request to pay for an online order from a user;
receive an image of a negotiable instrument from the user;
identify account information and payee information associated with the negotiable instrument based on the received image;
validate the account information and the payee information associated with the negotiable instrument;
responsive to validation of the account information and the payee information, the one or more processors further:
identify additional information associated with the negotiable instrument;
communicate the additional information to a validation service; and
receive an indication of whether the negotiable instrument is valid from the validation service.

17. The apparatus of claim 16, the validation of the account information and the payee information including the application of at least one payment validation rule to the account information and the payee information.

18. The apparatus of claim 16, the one or more processors further configured to authenticate a source of the negotiable instrument.

19. The apparatus of claim 16, the one or more processors further configured to validate available funds to satisfy a payment amount associated with the negotiable instrument.

20. The apparatus of claim 16, wherein the negotiable instrument is a physical check.
